(19) United States
(12) Patent Application Publication
(10) Pub. No.: US 2001/0047831 A1
(43) Pub. Date: Dec. 6, 2001

(54) Multiway valve (pilot valve container)

(76) Inventor: Peter Fagerstrom, Huddinge (SE)

Correspondence Address: Michael I. Wolfson, Esq., Cowan, Liebowitz & Latman, P.C., 1133 Avenue of the Americas, New York, NY, 10036-6799, US

(21) Appl. No.: 09/800,459

(22) Filed: Mar. 4, 2001

(30) Foreign Application Priority Data
Mar. 6, 2000 (DE) 100 12 066.0

(51) Int. Cl. F15B 13/044

(52) U.S. Cl. 137/625.65

(57) ABSTRACT

The present invention is related to a multiway valve for controlling the fluid flow of a pressure medium comprising a main valve (1) with an inner substantially axial opening which has inner chambers connected with corresponding outer ports (2), wherein at least one valve spool is guided axially movable in said axial opening for switching the fluid flow between said ports (2), wherein the valve spool is driven by at least one pilot valve (3, 4) mounted on the outer surface of the main valve (1), characterized in that the at least one pilot valve (3, 4) is surrounded by a container arrangement (5, 6) wherein its form is adjusted to the form of the main valve (1) in order to provide a clean surface between the main valve (1) and the at least one pilot valve (3, 4).

### FIELD OF THE INVENTION

This invention relates to a multiway valve assembly for controlling the fluid flow of a pressure medium. Especially, the present invention relates to a multiway valve driven by at least one pilot valve for moving switching means inside a main valve.

### DESCRIPTION OF RELATED ART

A valve assembly according to the preamble of claim 1 is known from the catalogue “Know-how in Pneumatics” (issue 1998, No. 00010 006 01, page 6.189f) of the assignee. The disclosed multiway valve is available with a 3/2, 5/2 or 5/3-function. The multiway valve comprises a main valve part by which the valve is mountable on a fluid manifold. On the surface of the main valve there are several ports, i.e. a supply port, delivery ports, and an exhaust port. The multiway valve has at least two switching positions, “opened” and “closed”, and it is controlled by air pressure provided from at least one pilot valve. The main valve is provided with an axial opening which has a plurality of steps to form inner chambers. The chambers are connected with the outer ports. The fluid flow of the pressure medium is controlled by a movable valve spool. Therefore the valve spool is axially guided in said opening. To move the valve spool in an axially manner, its one end is formed as a piston. The piston works together with a control-chamber shaped as a kind of fluid cylinder and integrated in the main valve so that the switching position of the multiway valve is controllable by the air pressure of the pilot valve or valves. In order to return the valve spool to the normal position, usually a spring is disposed between the valve spool and the main valve. The at least one pilot valve is attached on the top of the main valve. Thus the profile of the multiway valve has many edges and corners which are difficult to keep clean. Also the outer wiring affect adversely this aspect. The cleaning aspect is important in environments where a high hygienic standard is required, e.g. in the food industry.

It is the aim of the present invention to provide a multiway valve with at least one outer pilot valve which in contrast to the prior art is suitable to use in environments where a high hygienic standard is required.

### SUMMARY OF THE INVENTION

This aim is obtained in a multiway valve of the above-mentioned kind by using the features of the characterising position of claim 1. Thus the invention provides a container arrangement surrounding the at least one pilot valve. The form of the container arrangement is adjusted to the form of the main valve in order to provide a clean surface between the main valve and the pilot valve.

The present invention avoids stick of dirt and bacteria to edges and corners between the main valve and the pilot valve. Furthermore, the container arrangement protects the pilot valve from water penetration. The invention provides an easy retrofitable solution for well existing multiway valves with at least one pilot valve mounted on an outer surface of the main valve in order to provide a smooth, clean and hygienic surface.

In one preferred embodiment of the invention the container arrangement comprises a removable cap disposed on the top of the container arrangement. It might be favourable when the removable cap is fixed on the container arrangement by at least one screw or at least one clip element.

As a further advantageous development of the invention the container arrangement comprises an electrical connection part for connecting of the at least one inner pilot valve with an electrical distributor via a cable. The electrical connection part might be an electrical plug or a socket. Thus it is possible to dismount the electrical connection in an easy way. All of the wiring to the pilot valve or valves is inside the container arrangement and it is not visible from outside in order to provide a hygienic surface.

It is favourable when the container arrangement including the removable cap is a transfer-moulded part made by plastics or rubber material.

The foregoing and other aspects will become apparent from the following detailed description of the invention when considered in conjunction with the enclosed drawings.

### BRIEF DESCRIPTION OF THE DRAWINGS

FIG. 1 shows a perspective view of a container arrangement together with multiway valve elements.

FIG. 2 shows the container arrangement with the multiway valve as shown in FIG. 1 in the mounted state.

### DESCRIPTION OF THE PREFERRED EMBODIMENTS

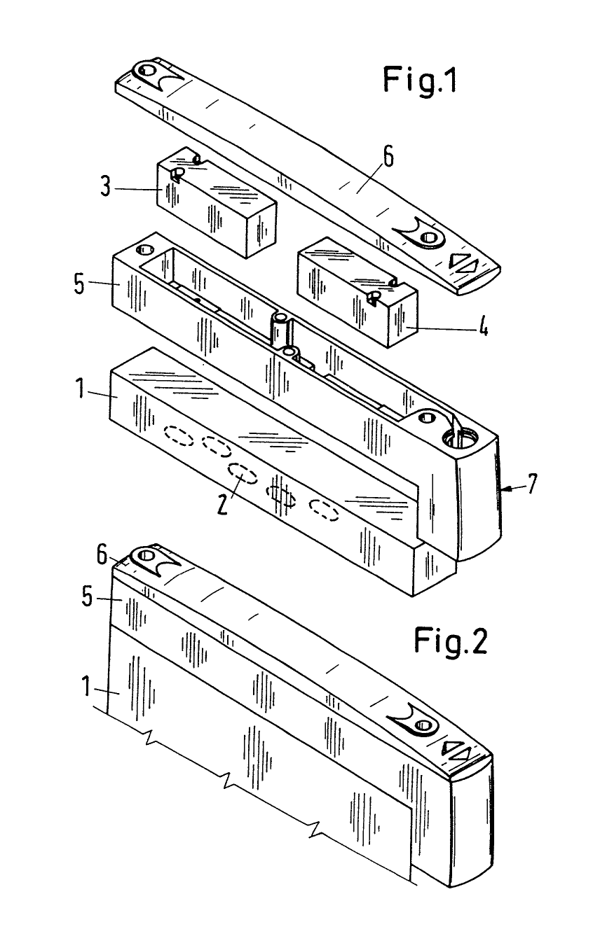

The multiway valve schematically shown in FIG. 1 comprises a main valve 1 with inner chambers which are connected with outer ports 2. One valve spool (not shown) is guided axially movable inside the main valve 1 in an opening for switching the fluid flow between the chambers and the ports 2 respectively. The valve spool is axially driven by two pilot valves 3 and 4. Both pilot valves 3 and 4 are mounted on the outer surface of the main valve 1. They are surrounded by a container arrangement 5, 6 made by plastics material. The container arrangement 5, 6 is also mounted on the outer surface of the main valve 1. It comprises a removable cap 6 disposed on the top of the container arrangement 5. The cap 6 is fixed on the other part of the container arrangement 5, 6 by two screws. Furthermore, the container arrangement 5, 6 comprises an electrical connection part 7 for connecting the pilot valves 3 and 4 with an (not shown) electrical distributor.

As shown in FIG. 2 in the mounted state the form of the container arrangement 5, 6 is adjusted to the form of the main valve 1. This provides a clean surface between the main valve 1 and the container arrangement 5, 6 in order to avoid stick of dirt and bacteria to edges and corners between the main valve 1 and the pilot valves 2 and 3.

The invention is not limited by the embodiments described above which are presented as examples only but can be modified in various way within the scope of protection defined by the appended patent claims. Especially, the invention is applicable on many kind of valves which has outer pilot valves.

1. A multiway valve for controlling the fluid flow of a pressure medium comprising a main valve (1) with an inner substantially axial opening which has inner chambers connected with corresponding outer ports (2), wherein at least one valve spool is guided axially movable in said axial opening for switching the fluid flow between said ports (2), wherein the valve spool is driven by at least one pilot valve (3, 4) mounted on the outer surface of the main valve (1), characterized in that the at least one pilot valve (3, 4) is surrounded by a container arrangement (5, 6) wherein its form is adjusted to the form of the main valve (1) in order to provide a clean surface between the main valve (1) and the at least one pilot valve (3, 4).

2. A multiway valve assembly according to claim 1, characterized in that the container arrangement (5, 6) comprises a removable cap (6) disposed on the top of the container arrangement (5, 6).

3. A multiway valve assembly according to claim 1, characterized in that the removable cap (6) is fixed on the container arrangement (5, 6) by at least one screw or at least one clip element.

4. A multiway valve assembly according to claim 1, characterized in that between one part of the container arrangement (5, 6) and the removable cap (6) is disposed a separate sealing element.

5. A multiway valve assembly according to claim 1, characterized in that the container arrangement (5, 6) comprises an electrical connection part (7) for connecting the at least one inner pilot valve (3, 4) with an electrical distributor via a cable.

6. A multiway valve assembly according to claim 5, characterized in that the electrical connection part (7) is an electrical plug or a socket for dismounting the electrical connection.

7. A multiway valve assembly according to claim 1, characterized in that the container arrangement (5, 6) is disposed to the sides or on the top of the main valve (1) where the at least one pilot valve (3, 4) is placed.

8. A multiway valve assembly according to claim 1, characterized in that the container arrangement (5, 6) is a transfer-moulded part made by plastics or rubber material.
